(19) United States
(12) Patent Application Publication
(10) Pub. No.: US 2006/0070318 A1
(43) Pub. Date: Apr. 6, 2006

(54) Glass door

(76) Inventors: Yung-Fung Chen, Taoyuan City (TW); Yen-Hwang Yang, Taichung City (TW); Pao-Lou Chang, Guansi Township (TW)

Correspondence Address: PRO-TECHTOR INTERNATIONAL SERVICES, 20775 Norada Court, Saratoga, CA, 95070-3018, US

(21) Appl. No.: 10/950,204

(22) Filed: Sep. 24, 2004

(51) Int. Cl. E06B 3/00; E06B 3/964

(52) U.S. Cl. 52/204.65; 52/204.5

(57) ABSTRACT

A glass door includes a pane of glass securely held by upper and lower frames. A clamping device is mounted in an outer groove of each frame and includes an outer clamping member mounted in the outer groove and an inner clamping member mounted in the outer clamping member. Each of two limbs of the inner clamping member includes an inclined outer face abutting against an inwardly facing inclined face of an associated limb of the outer clamping member. A lining member is sandwiched between an associated end of the pane of glass and inner faces of the limbs of the inner clamping member. A bolt extends through the outer clamping member and the inner clamping member. When the bolt is turned, the limbs of the inner clamping member are moved toward each other to tightly clamp the associated end of the pane of glass or away from each other.

### BACKGROUND OF THE INVENTION

1. Field of the Invention

The present invention relates to a glass door. In particular, the present invention relates to a glass door that is easy to assemble.

2. Description of the Related Art

A typical glass door includes a pane of glass 12 mounted between an upper frame 10 and a lower frame 11, as illustrated in FIG. 1 of the drawings. In assembly, a lower end of the pane of glass 12 is mounted into a groove (not labeled) in the lower frame 11 and adhesive 13 is then poured into the groove of the lower frame 11. After fixing of the lower end of the pane of glass 12 in the lower frame 11, an upper end of the pane of glass 12 is mounted into a groove (not labeled) in the upper frame 10 and adhesive 13 is then poured into the groove of the upper frame 10. After fixing of the upper end of the pane of the glass 12 in the upper frame 10, silicon rubber 14 is applied to seal the upper end face of the lower frame 11 and the lower end face of the upper frame 10. The whole procedure for assembling the glass door is troublesome and time-consuming. Further, adjustment is not allowed when any mistake is made during the assembling procedure.

### SUMMARY OF THE INVENTION

In accordance with an aspect of the present invention, a glass door comprises a pane of glass and upper and lower frames for securely holding upper and lower ends of the pane of glass. Each frame includes a partitioning wall to define an outer groove. A clamping device is mounted in each outer groove and comprises an outer clamping member, an inner clamping member, and a lining member.

The outer clamping member is mounted in the outer groove and includes an intermediate section and two limbs. Each limb of the outer clamping member includes an inwardly facing inclined face. The intermediate section of the outer clamping member includes at least one through-hole.

The inner clamping member is mounted in the outer clamping member and includes an intermediate section and two limbs. Each limb of the inner clamping member includes an inner face and an inclined outer face abutting against the inwardly facing inclined face of an associated limb of the outer clamping member. The intermediate section of the inner clamping member includes at least one screw hole. The lining member is sandwiched between an associated end of the pane of glass and the inner faces of the limbs of the inner clamping member.

A bolt extends through the through-hole of the outer clamping member and the screw hole of the inner clamping member. When the bolt is turned, the inner clamping member is moved such that the limbs of the inner clamping member are moved toward each other to tightly clamp the associated end of the pane of glass or away from each other. The glass door in accordance with the present invention can be assembled easily and reliably without the need of adhesive and silicon rubber. If necessary, adjustment can be carried out during the assembling procedure.

Each inner face of each limb of the inner clamping member includes a serrated section to assist in secure engagement between the lining member and the associated side of the pane of glass.

Each of the lower end of the upper frame and the upper end of the lower frame includes an end wall having a slot through which an associated one of the upper end and the lower end of the pane of glass extends. The associated one of the upper end and the lower end of the pane of glass is close to two sides delimiting the slot of the end wall. Thus, no silicon rubber is required for sealing purposes.

The outer clamping member defines a compartment with an opening. The inner clamping member defines a compartment with an opening that is aligned with the opening of the outer clamping member.

Each limb of the outer clamping member includes a ledge protruding inward from each inner face of each limb. The lining member includes an intermediate section resting on the ledges.

The partitioning wall includes an engaging member. The bolt includes a bolt head that impinges the engaging member when the pane of glass is not tightly clamped by the inner clamping member, not allowing one of the upper end and the lower end of the pane of glass to be inserted into an outer groove. The bolt head is not obstructed by the engaging member when the pane of glass is tightly clamped by the inner clamping member while inserting one of the upper end and the lower end of the pane of glass into the outer groove.

Other objectives, advantages, and novel features of the invention will become more apparent from the following detailed description when taken in conjunction with the accompanying drawings.

### BRIEF DESCRIPTION OF THE DRAWINGS

FIG. 1 is a sectional view of a conventional glass door.

FIG. 2 is a sectional view of a glass door in accordance with the present invention.

FIG. 3 is a perspective view of a pane of glass and a clamping device for clamping a lower end of the pane of glass of the glass door in accordance with the present invention.

FIG. 4 is an exploded perspective view of a lower frame and associated elements of the glass door in accordance with the present invention.

FIG. 5 is an exploded perspective view of the pane of glass and the clamping device in FIG. 3.

FIG. 6 is a sectional view of the pane of glass and the clamping device in FIG. 3, wherein the clamping device is not in a tightening position.

FIG. 7 is a view similar to FIG. 6, wherein the clamping device is in a state not allowing coupling with the lower frame.

FIG. 8 is a view similar to FIG. 6, wherein the clamping device is in the tightening position.

FIG. 9 is a view similar to FIG. 7, wherein the clamping device in the tightening position allowing coupling with the lower frame.

### DETAILED DESCRIPTION OF THE PREFERRED EMBODIMENT

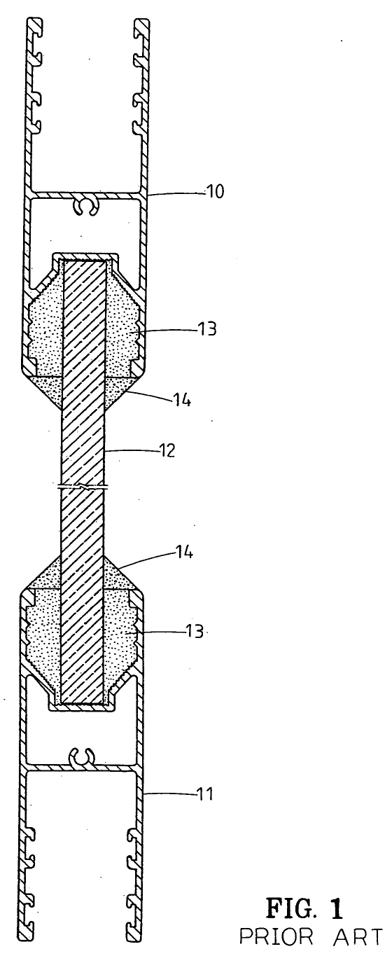

Referring to FIG. 1, a glass door in accordance with the present invention comprises an upper frame 20, a lower frame 21, and a pane of glass 70 mounted between the upper frame 20 and the lower frame 21. Two clamping devices are provided for respectively fixing upper and lower ends of the pane of glass 70 to a lower of the upper frame 20 and an upper end of the lower frame 21. Each clamping device includes an outer clamping member 30, an inner clamping member 40, and a lining member 50. Coupling of the upper end of the pane of glass 70 to the lower end of the upper frame 20 by one of the clamping devices is identical to coupling of the lower end of the pane of glass 70 to the upper end of the lower frame 21 by the other clamping device. Further, the lower end of the upper frame 20 and the upper end of the lower frame 21 are symmetrically constructed. Thus, only coupling of the lower end of the pane of glass 70 to the upper end of the lower frame 21 is disclosed hereinafter.

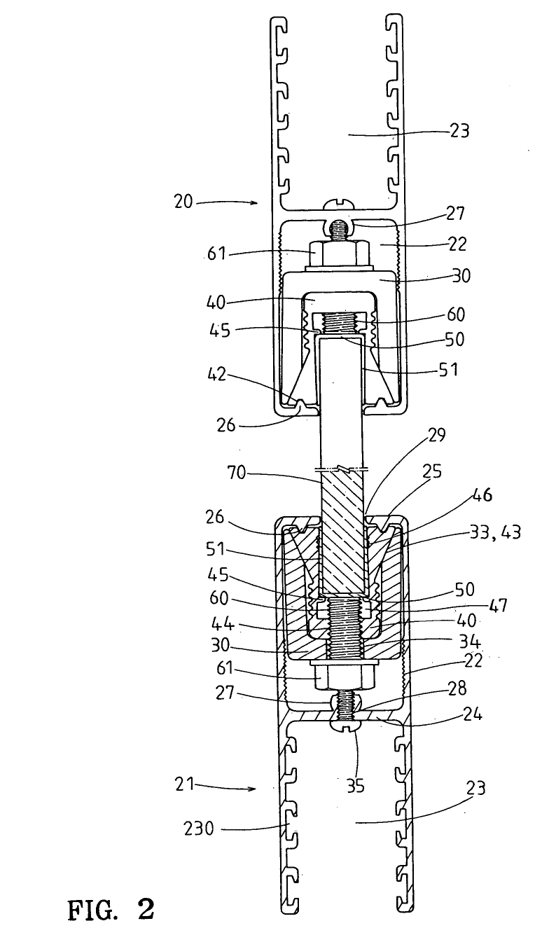

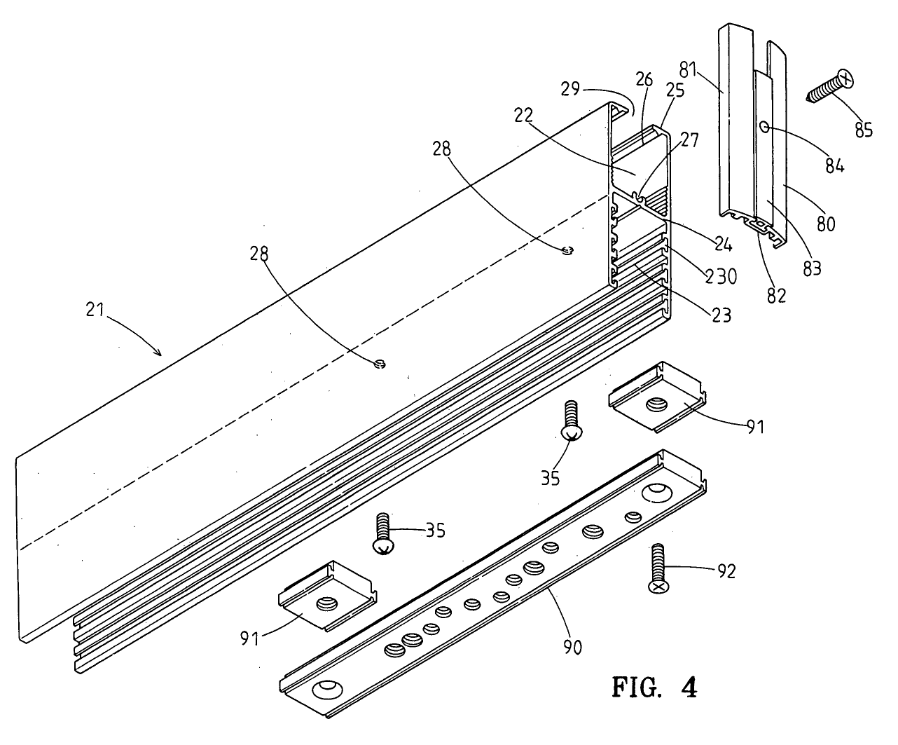

The lower frame 21 includes a partitioning wall 24 in the upper end thereof, defining an inner groove 23 and an outer groove 22 facing the pane of glass 70. At least one screw hole 28 (two in this embodiment, see FIG. 4) is defined in the partitioning wall 24. The upper end of the lower frame 21 includes an end wall 25 with two positioning ridges 26 on an inner face thereof. As illustrated in FIGS. 2 and 4, the end wall 25 includes a slot 29 through which the lower end of the pane of glass 70 extends. Referring to FIG. 4, a side cover 80 is attached to each of two lateral sides of the lower frame 21. The side cover 80 includes a groove 82 into which a resilient rubber strip 83 is inserted. A screw 85 is extended through a screw hole 84 of the resilient rubber strip 83 and a screw hole (not labeled) of an engaging member 27 of the lower frame 21. The side cover 80 includes two lateral walls 81 configured corresponding to a width of the lower frame 21. Similarly, a side cover is attached to each of two lateral sides of the upper frame 20.

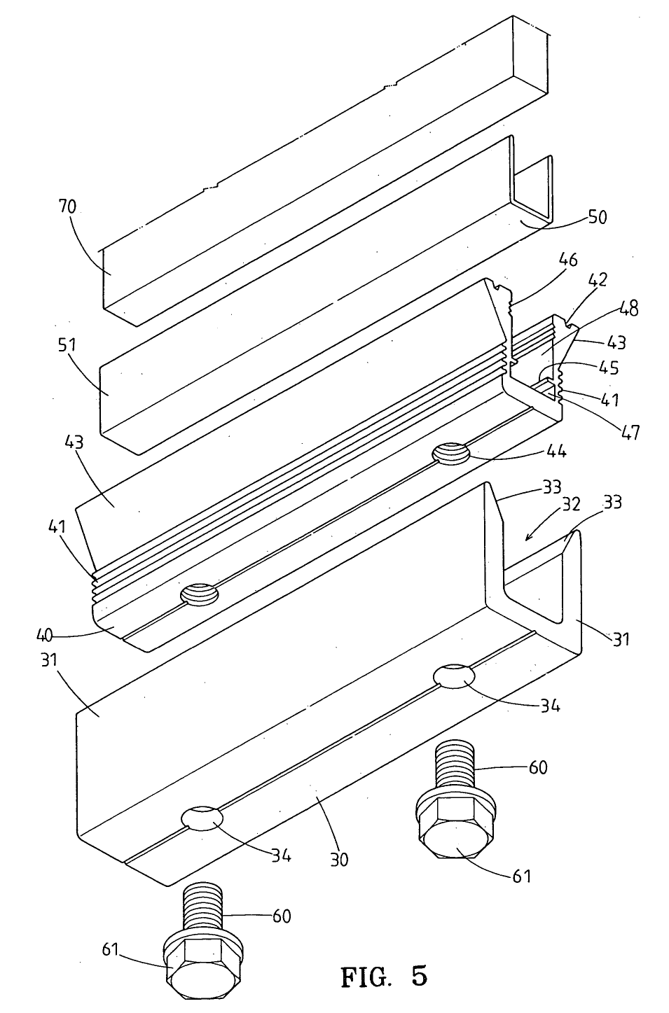

As illustrated in FIG. 5, the outer clamping member 30 of each clamping device is a substantially U-shaped member including an intermediate section and two limbs 31, defining a compartment with an opening 32. Each limb 31 has an inwardly facing inclined face 33. The intermediate section of the outer clamping member 30 includes at least one through-hole 34 (two in this embodiment).

Referring to FIGS. 2 and 5, the inner clamping member 40 of each clamping device is also a substantially U-shaped member mounted in the compartment of an associated outer clamping member 30. The inner clamping member 40 includes an intermediate section and two limbs 41, defining a compartment with an opening. At least one screw hole 44 (two in this embodiment, see FIG. 5) is defined in the intermediate section of the inner clamping member 40. Referring to FIG. 5, each limb 41 of the inner clamping member 40 includes an inclined outer face 43 and an inner face with a serrated section 46. A ledge 45 protrudes inward from the inner face of each limb 41, separating the compartment into an inner chamber 47 and an outer chamber 48 that receives the lower end of the pane of glass 70. Further, each limb 41 of the inner clamping member 40 includes a positioning groove 42 in an end face thereof.

As illustrated in FIG. 2, the inclined outer face 43 of each limb 41 of the inner clamping member 40 abuts against the inwardly facing inclined face 33 of the associated limb 31 of the outer clamping member 30. Each positioning ridge 26 of the lower frame 21 is received in an associated positioning groove 42 of the inner clamping member 40. Preferably, each positioning groove 42 has a width greater than that of the associated positioning ridge 26. The lining member 50 is substantially U-shaped and mounted to the lower end of the pane of glass 70. Each limb 51 is sandwiched between the inner face of an associated limb 41 and an associated side of the pane of glass 70. The serrated section 46 of each limb 41 assists in secure engagement between each limb 41 and the associated side of the pane of glass 70. The intermediate section of the lining member 50 rests on the ledges 45.

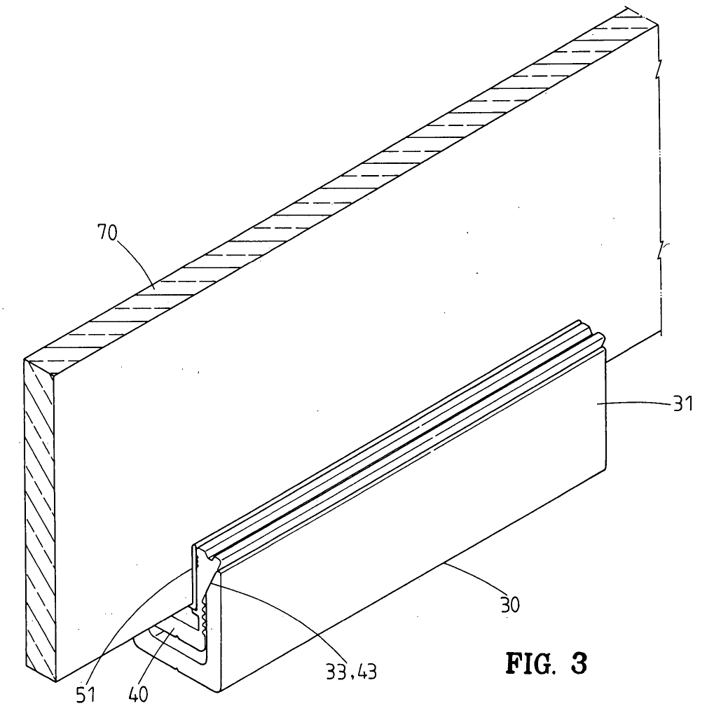

As illustrated in FIGS. 2, 3 and 5, a bolt 60 is extended through each through-hole 34 of the outer clamping member 30 and an associated screw hole 44 of the inner clamping member 40 into the inner chamber 47 of the inner clamping member 40, with a bolt head 61 of the bolt 60 being located in the outer groove 22 of the upper frame 21. Rotation of the bolt 60 causes the inner clamping member 40 to move, such that the inclined outer face 43 of each limb 41 of the inner clamping member 40 slides along the inwardly facing inclined face 33 of the associated limb 31 of the outer clamping member 30. In a case that the bolt 60 is driven in a direction causing the limbs 41 to move toward each other, the lower end of the pane of glass 70 is tightly clamped by the limbs 41 of the inner clamping member 40. On the other hand, if the bolt 60 is driven in a reverse direction causing the limbs 41 to move away from each other, the clamping force provided by the limbs 41 becomes smaller.

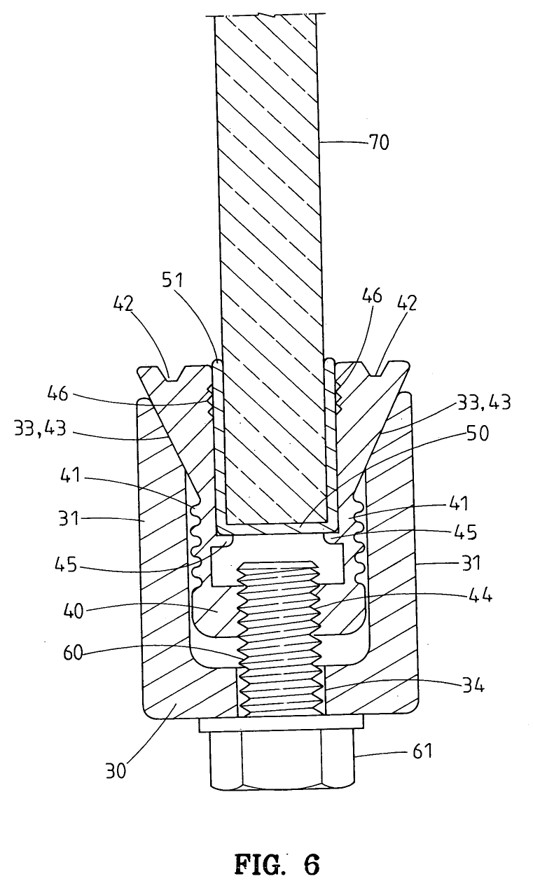

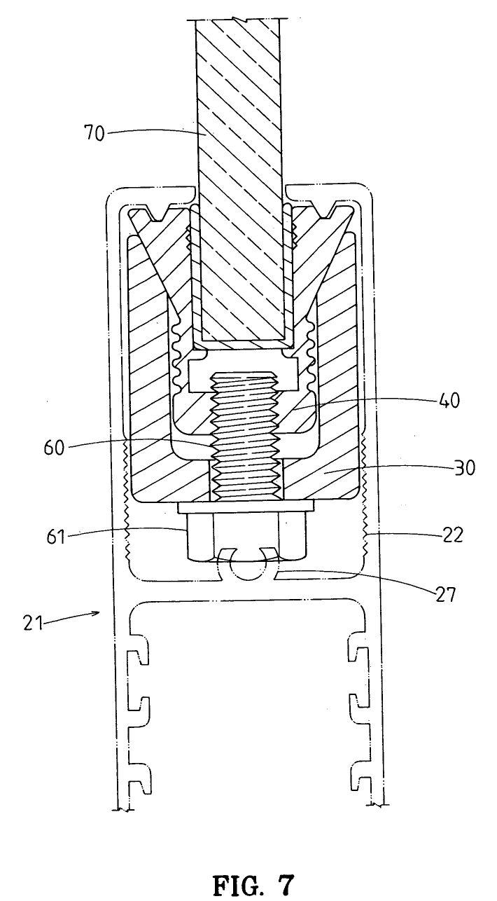

Referring to FIGS. 6 and 7, the inner clamping member 40 is not in a tightening position. The bolt head 61 would impinge the engaging member 27 of the lower frame 21. In other words, the lower end of the pane of glass 70 and the associated clamping device could not be mounted into the outer groove 22 of the lower frame 21.

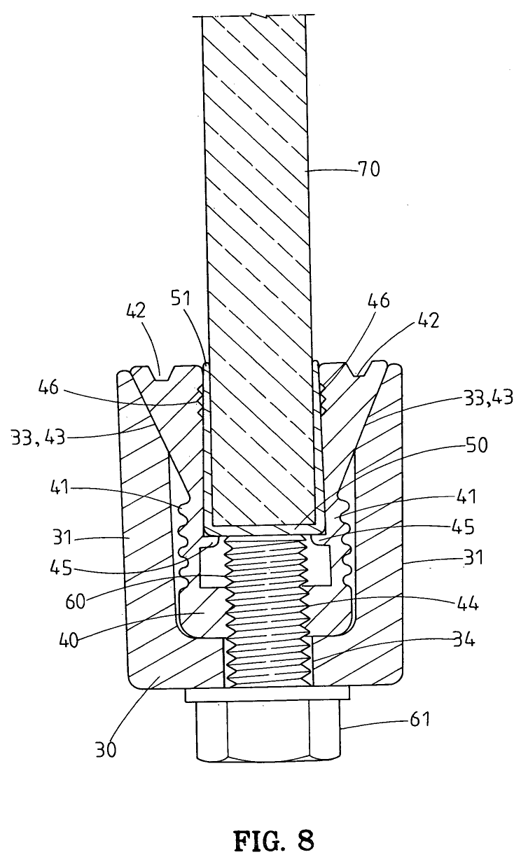

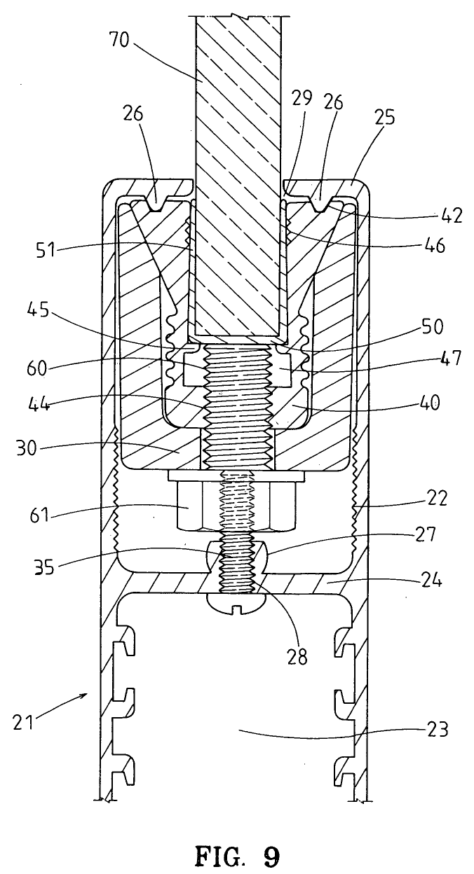

The bolt head 61 can be turned to move the inner clamping member 40 to the tightening position shown in FIGS. 8 and 9. Thus, the overall longitudinal length of the clamping device (including the bolt head 61) is reduced, allowing insertion of the lower end of the pane of glass 70 and the clamping device into the outer groove 22 of the lower frame 21. Next, a screw 35 is extended through each screw hole 28 until a distal end of the bolt 60 pressing against the lining member 50. As illustrated in FIG. 4, a plurality of fixing blocks 91 and a fixing plate 90 are mounted into a plurality of track grooves 230 defined in two sidewalls delimiting the inner groove 23, and screws 92 are used to secure the fixing blocks 91 and the fixing plate 90, thereby fixing other associated elements of the glass door, which is conventional.

Preferably, the opening of the inner clamping member 40 is at the same level as the opening 32 of the outer clamping member 30. The end wall 25 of the lower frame 21 is higher than the opening (not labeled) of the lining member 50. The gap between each side of the lower end of the pane of glass 70 and an associated side (not labeled) delimiting the slot 29 of the end wall 25 is so small that no silicon rubber is required for sealing purposes.

The glass door in accordance with the present invention can be assembled easily and reliably without the need of adhesive and silicon rubber. If necessary, adjustment can be carried out during the assembling procedure.

Although a specific embodiment has been illustrated and described, numerous modifications and variations are still possible without departing from the essence of the invention. The scope of the invention is limited by the accompanying claims.

What is claimed is:

1. A glass door comprising a pane of glass (70), an upper frame (20) having a lower end for securely holding an upper end of the pane of glass (70), and a lower frame (21) having an upper end for securely holding a lower end of the pane of glass (70), each of the lower end of the upper frame and the upper end of the lower frame including a partitioning wall (24) to define an outer groove (22), a clamping device being mounted in each said outer groove (22), said clamping device comprising:
an outer clamping member (30) mounted in said outer groove (22) and including an intermediate section and two limbs (31), each said limb of said outer clamping member including an inwardly facing inclined face (33), the intermediate section of said outer clamping member (30) including at least one through-hole (34);
an inner clamping member (40) mounted in said outer clamping member (30) and including an intermediate section and two limbs (41), each said limb of said inner clamping member including an inner face and an inclined outer face (43) abutting against said inwardly facing inclined face (33) of an associated one of said limbs (31) of said outer clamping member (30), the intermediate section of said inner clamping member (40) including at least one screw hole (44);
a lining member (50) sandwiched between an associated end of the pane of glass (70) and said inner faces of said limbs (41) of said inner clamping member (40); and
at least one bolt (60) extending through said at least one through-hole (34) of said outer clamping member (30) and said at least one screw hole (44) of said inner clamping member (40);
wherein when said at least one bolt (60) is turned, said inner clamping member (40) is moved such that said limbs (41) of said inner clamping member (40) are moved toward each other to tightly clamp the associated end of the pane of glass or away from each other.

2. The glass door as claimed in claim 1 wherein each said inner face of each said limb (41) of said inner clamping member (40) includes a serrated section (46).

3. The glass door as claimed in claim 1 wherein each of said lower end of the upper frame and the upper end of the lower frame includes an end wall (25) having a slot (29) through which an associated one of the upper end and the lower end of the pane of glass (70) extends, the associated one of the upper end and the lower end of the pane of glass being close to two sides delimiting the slot (29) of the end wall (25).

4. The glass door as claimed in claim 1 wherein said outer clamping member (30) defines a compartment with an opening (32), and wherein said inner clamping member (40) defines a compartment with an opening that is aligned with the opening (32) of said outer clamping member.

5. The glass door as claimed in claim 1 wherein each said limb (41) of said outer clamping member (40) includes a ledge (45) protruding inward from each said inner face of each said limb (40), and wherein said lining member (50) includes an intermediate section resting on said ledges (45).

6. The glass door as claimed in claim 1 wherein said partitioning wall (24) includes an engaging member (27), and wherein said at least one bolt (60) includes a bolt head (61) that impinges the engaging member (27) when the pane of glass is not tightly clamped by said inner clamping member (40), not allowing one of the upper end and the lower end of the pane of glass to be inserted into said outer groove (22).

7. The glass door as claimed in claim 6 wherein said bolt head (61) is not obstructed by the engaging member (27) when the pane of glass is tightly clamped by said inner clamping member (40) while inserting one of the upper end and the lower end of the pane of glass into said outer groove (22).
